(19) United States
(12) Patent Application Publication
(10) Pub. No.: US 2025/0245451 A1
(43) Pub. Date: Jul. 31, 2025

(54) MODEL TRAINING METHODS AND APPARATUSES AND TASK EXECUTION METHODS AND APPARATUSES

(71) Applicant: Alipay (Hangzhou) Information Technology Co., Ltd., Hangzhou (CN)

(72) Inventors: Ningtao Wang, Hangzhou (CN); Xing Fu, Hangzhou (CN); Weiqiang WANG, Hangzhou (CN)

(73) Assignee: Alipay (Hangzhou) Information Technology Co., Ltd., Hangzhou (CN)

(21) Appl. No.: 19/042,469

(22) Filed: Jan. 31, 2025

(30) Foreign Application Priority Data
Jan. 31, 2024 (CN) 202410139381.5

(51) Int. Cl. G06F 40/40

(52) U.S. Cl. CPC G06F 40/40

(57) ABSTRACT

This specification discloses methods and apparatuses for model training and a task execution. An example model training method includes: obtaining behavior sequence data; converting event data of each behavior event included in the obtained behavior sequence data into text data, to obtain behavior text data corresponding to the behavior sequence data; then, inputting the obtained behavior text data into a to-be-trained recognition model, so that the to-be-trained recognition model outputs a recognition result for the behavior sequence data as a to-be-verified result based on the input behavior text data; and training the to-be-trained recognition model with an optimization objective of minimizing a deviation between the to-be-verified result output by the recognition model and an actual recognition result corresponding to the behavior sequence data.

### CROSS-REFERENCE TO RELATED APPLICATIONS

This application claims priority to Chinese Patent Application No. 202410139381.5, filed on Jan. 31, 2024, which is hereby incorporated by reference in its entirety.

### TECHNICAL FIELD

This specification relates to the field of computer technologies, and in particular, to model training methods and apparatuses and task execution methods and apparatuses.

### BACKGROUND

With rapid development of the Internet, people increasingly frequently use intelligent devices, and various types of applications on the intelligent devices provide diversified services for people. However, because different users have different use habits and operation habits, many application developers are committed to customizing more comfortable personalized experience for users based on the use habits and operation habits of different users.

Currently, when authorization from users is obtained, developers can obtain specific operation behaviors involved in a process of using applications by the users and specific data involved in the operation behaviors, and generate behavior information corresponding to the users based on the data, to customize more comfortable personalized experience for each user based on behavior information corresponding to the user.

However, before an application is launched, there is usually no user behavior information available for use. Developers usually use artificial intelligence programs to perform simulation and generate simulated behavior information. The simulated behavior information can assist the developers in developing application programs that better match user habits. In addition, the simulated behavior information can help the developers test security issues that may potentially occur in the application. It can be said that generation of the simulated behavior information has always been an indispensable part of application development on intelligent devices. However, the simulated behavior information generated through simulation by using the artificial intelligence programs is not always accurate, and may sometimes result in abnormal orders of operations. This simulated, abnormal user behavior information possibly cannot accurately reflect behavior habit characteristics of users, bringing difficulties to development work of the developers.

Therefore, how to effectively determine authenticity of the simulated behavior information and help application developers develop better products through more realistic simulated behavior information is an urgent problem to be resolved.

### SUMMARY

This specification provides model training methods and apparatuses and task execution methods and apparatuses, to partially resolve the above-mentioned problem in the conventional technology.

The following technical solutions are used in this specification.

This specification provides a model training method, including: obtaining behavior sequence data, where the behavior sequence data include event data of each behavior event corresponding to a user, and for each behavior event, the event data of the behavior event include a plurality of pieces of attribute data used to describe the behavior event; converting the event data of each behavior event included in the behavior sequence data into text data, to obtain behavior text data corresponding to the behavior sequence data; inputting the behavior text data into a to-be-trained recognition model, so that the recognition model outputs a recognition result for the behavior sequence data as a to-be-verified result based on the behavior text data, where the recognition result output by the recognition model is used to determine whether the behavior sequence data are realistic behavior sequence data of the user; and training the recognition model with an optimization objective of minimizing a deviation between the to-be-verified result and an actual recognition result corresponding to the behavior sequence data.

Optionally, for any attribute data included in the behavior sequence data, the attribute data are represented by using an attribute name and an attribute value corresponding to the attribute name; and the converting the event data of each behavior event included in the behavior sequence data into text data, to obtain behavior text data corresponding to the behavior sequence data specifically includes: for each piece of attribute data included in the behavior sequence data, connecting an attribute name and an attribute value in the attribute data by using one or more predetermined text characters, to obtain attribute text data corresponding to the attribute data; and obtaining the behavior text data corresponding to the behavior sequence data based on the attribute text data corresponding to each piece of attribute data included in the behavior sequence data.

Optionally, before the inputting the behavior text data into a to-be-trained recognition model, the method further includes: obtaining out-of-order text data corresponding to the behavior sequence data, where the out-of-order text data are obtained after a location of attribute data in event data of at least some behavior events included in the behavior sequence data in the event data to which the attribute data belong is rearranged; and the inputting the behavior text data into a to-be-trained recognition model, so that the recognition model outputs a recognition result for the behavior sequence data as a to-be-verified result based on the behavior text data specifically includes: inputting the out-of-order text data into the to-be-trained recognition model, so that the recognition model outputs the recognition result for the behavior sequence data as the to-be-verified result based on the out-of-order text data.

This specification provides a task execution method, including: obtaining to-be-recognized behavior sequence data; converting event data of each behavior event included in the to-be-recognized behavior sequence data into text data, to obtain behavior text data corresponding to the to-be-recognized behavior sequence data; inputting the behavior text data into a pre-trained recognition model, to obtain a recognition result for the to-be-recognized behavior sequence data by using the recognition model, where the recognition result output by the recognition model is used to determine whether the to-be-recognized behavior sequence data are realistic behavior sequence data of a user, and the recognition model is obtained through training by using the above-mentioned model method; and executing a target task based on the recognition result.

Optionally, the obtaining to-be-recognized behavior sequence data specifically includes: generating simulated behavior sequence data by using a predetermined behavior sequence generation model; and using the simulated behavior sequence data as the to-be-recognized behavior sequence data.

Optionally, the executing a target task based on the recognition result specifically includes: if it is determined, based on the recognition result, that the to-be-recognized behavior sequence data are the realistic behavior sequence data of the user, adding the behavior sequence data to a predetermined target dataset, to execute the target task based on each piece of behavior sequence data included in the target dataset.

This specification provides a model training apparatus, including: an acquisition module, configured to obtain behavior sequence data, where the behavior sequence data include event data of each behavior event corresponding to a user, and for each behavior event, the event data of the behavior event include a plurality of pieces of attribute data used to describe the behavior event; a processing module, configured to convert the event data of each behavior event included in the behavior sequence data into text data, to obtain behavior text data corresponding to the behavior sequence data; a recognition module, configured to input the behavior text data into a to-be-trained recognition model, so that the recognition model outputs a recognition result for the behavior sequence data as a to-be-verified result based on the behavior text data, where the recognition result output by the recognition model is used to determine whether the behavior sequence data are realistic behavior sequence data of the user; and a training module, configured to train the recognition model with an optimization objective of minimizing a deviation between the to-be-verified result and an actual recognition result corresponding to the behavior sequence data.

This specification provides a task execution apparatus, including: an acquisition module, configured to obtain to-be-recognized behavior sequence data; a processing module, configured to convert event data of each behavior event included in the to-be-recognized behavior sequence data into text data, to obtain behavior text data corresponding to the to-be-recognized behavior sequence data; a recognition module, configured to input the behavior text data into a pre-trained recognition model, to obtain a recognition result for the to-be-recognized behavior sequence data by using the recognition model, where the recognition result output by the recognition model is used to determine whether the to-be-recognized behavior sequence data are realistic behavior sequence data of a user, and the recognition model is obtained through training by using the above-mentioned model method; and an execution module, configured to execute a target task based on the recognition result.

This specification provides a computer-readable storage medium. The storage medium stores a computer program, and when the computer program is executed by a processor, the above-mentioned model training method and task execution method are implemented.

This specification provides an electronic device, including a storage, a processor, and a computer program that is stored in the storage and that is capable of running on the processor. When the processor executes the program, the above-mentioned model training method and task execution method are implemented.

The above-mentioned at least one technical solution used in this specification can achieve the following beneficial effects:

In the model training method provided in this specification, first, behavior sequence data need to be obtained, where the behavior sequence data include event data of each behavior event corresponding to a user, and for each behavior event, the event data of the behavior event include a plurality of pieces of attribute data used to describe the behavior event; then, an attribute name and an attribute value in each piece of attribute data included in the behavior sequence data are connected by using one or more predetermined text characters, to obtain attribute text data corresponding to each piece of attribute data, so as to obtain behavior text data corresponding to the behavior sequence data; and finally, a location of attribute data in event data of at least some behavior events included in the behavior sequence data in the event data to which the attribute data belong is rearranged, to obtain out-of-order text data corresponding to the behavior sequence data, and the out-of-order text data corresponding to the behavior sequence data are input into a to-be-trained recognition model, so that the recognition model outputs a recognition result for the behavior sequence data as a to-be-verified result based on the out-of-order text data, and the recognition model is trained with an optimization objective of minimizing a deviation between the to-be-verified result and an actual recognition result corresponding to the behavior sequence data.

It can be seen from the above-mentioned method that in this specification, the event data of each behavior event included in the behavior sequence data can be converted into text data, the behavior text data corresponding to the behavior sequence data can be obtained, the location of the attribute data in the event data of at least some behavior events included in the behavior sequence data in the event data to which the attribute data belong is rearranged, to obtain the out-of-order text data corresponding to the behavior sequence data, and finally, the out-of-order text data are used as a training sample to train the recognition model, to finally obtain a recognition model that can determine authenticity of the behavior sequence. This allows application developers to use the recognition model to evaluate the authenticity of simulated behavior information, which aids developers in creating better products and improves the efficiency of application development.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic flowchart illustrating model training, according to this specification;

FIG. 2 is a schematic flowchart illustrating task execution, according to this specification;

FIG. 3 is a schematic diagram illustrating a model training apparatus, according to

this specification;

FIG. 4 is a schematic diagram illustrating a task execution apparatus, according to this specification; and

FIG. 5 is a schematic structural diagram illustrating an electronic device corresponding to FIG. 1 or FIG. 2, according to this specification.

### DESCRIPTION OF EMBODIMENTS

To make the objectives, technical solutions, and advantages of this specification clearer, the following clearly and comprehensively describes the technical solutions of this specification with reference to specific embodiments and corresponding accompanying drawings of this specification. Clearly, the described embodiments are merely some but not all of embodiments of this specification. All other embodiments obtained by a person of ordinary skill in the art based on the embodiment of this specification without creative efforts shall fall within the protection scope of this specification.

The following describes in detail the technical solutions provided in the embodiments of this specification with reference to the accompanying drawings.

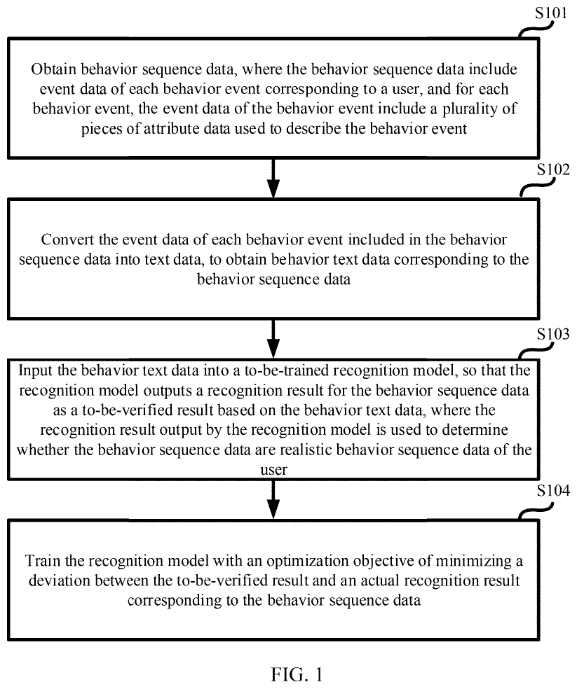

FIG. 1 is a schematic flowchart illustrating a model training method, according to this specification. The method includes the following steps.

S101: Obtain behavior sequence data, where the behavior sequence data include event data of each behavior event corresponding to a user, and for each behavior event, the event data of the behavior event include a plurality of pieces of attribute data used to describe the behavior event.

Currently, with rapid development of the Internet, various types of applications on intelligent devices provide diversified services for people and enrich people's lives. However, different users have different use habits and use needs when using applications on the intelligent devices. In this case, application developers need to customize more comfortable personalized experience for users based on use habits of different users. Simulated behavior information generated through simulation by using artificial intelligence programs can assist the developers in developing application programs that better match user habits. However, the simulated behavior information generated through simulation by using the artificial intelligence programs is not always accurate, and unrealistic simulated behavior information cannot help the developers, but may affect a development process of the developers.

Based on this, this specification provides a model training method. By determining the simulated behavior information, realistic model behavior information is recognized, to help an application developer develop a better product.

It is worthwhile to note that in this specification, the method for implementing model training can be performed by a specified device such as a server, or can be performed by a terminal device such as a desktop computer or a laptop computer, or can be performed by a client installed in a terminal device. For case of description, in this specification, only an example in which the server is an execution body is used to describe the model training method provided in this specification.

In this specification, the server can obtain the behavior sequence data. The behavior sequence data include the event data of each behavior event corresponding to the user. Generally, all behaviors that are performed by the user and that need interaction with a backend server of an application can be considered as behavior events. For example, if a user performs one “transfer” operation, the “transfer” operation is one behavior event, and the backend server of the application records event data of the “transfer” operation as a behavior event in a behavior sequence corresponding to the user. In each behavior event, the event data of the behavior event include a plurality of pieces of attribute data used to describe the behavior event. The “transfer” operation is still used as an example, and a “transfer time”, a “transfer amount”, a “transfer object”, and other data involved in the “transfer” operation are a plurality of pieces of attribute data involved in the “transfer” operation event.

It is worthwhile to note that for each user, when authorization from the user is obtained, all behaviors that are performed by the user and that need interaction with the backend server of the application are recorded by the backend server of the application. In addition, based on a need of the developer, when authorization from the user is obtained, the backend server of the application can periodically collect some behaviors of not interacting with the backend server of the application by the user, and also use the behaviors as behavior events in a behavior sequence corresponding to the user.

In this description, the server can obtain the behavior sequence data from specified storage space through a predetermined interface, and store the behavior sequence data in local space, to process, in a subsequent process, the behavior sequence data stored in the local space.

S102: Convert the event data of each behavior event included in the behavior sequence data into text data, to obtain behavior text data corresponding to the behavior sequence data.

The server can convert the event data of each behavior event included in the obtained behavior sequence data into text data, to obtain the behavior text data corresponding to the behavior sequence data.

The behavior sequence data corresponding to the user is usually stored in a data table. In this specification, a to-be-trained recognition model used can be an artificial intelligence model such as a large language model with relatively strong performance. For example, the large language model is used as an example. Compared with a conventional deep learning model, the large language model has more model parameters, which means stronger model performance. It can be said that recognition accuracy and recognition efficiency can be greatly improved when authenticity of the simulated behavior information is recognized by using the large language model.

Therefore, to adapt to the recognition model, the server can convert the original structured behavior sequence data into textual behavior sequence data, to obtain the behavior text data corresponding to the behavior sequence data.

For each piece of attribute data included in the behavior sequence data, the server can connect an attribute name and an attribute value in the attribute data by using one or more predetermined text characters, to obtain attribute text data corresponding to the attribute data; and then obtain the behavior text data corresponding to the behavior sequence data based on the attribute text data corresponding to each piece of attribute data included in the behavior sequence data.

For example, if a user transfers “1000” yuan to “Tom” at “8:00” in the morning, in a behavior event corresponding to the “transfer” operation, attribute values corresponding to attribute data such as a “transfer time”, a “transfer amount”, and a “transfer object” are respectively “8:00”, “1000”, and “Tom”, and corresponding attribute text data can be “the transfer time is 8:00”, “the transfer amount is 1000”, and “the transfer object is Tom”, where “is” is a predetermined character, and is used to connect an attribute name and an attribute value in the attribute data. Certainly, in an actual service scenario, a specific form of the predetermined character can be determined through comprehensive analysis based on an actual situation.

The server can connect attribute names and attribute values in all attribute data included in the behavior sequence data by using the one or more predetermined text characters, to obtain attribute text data corresponding to all the attribute data; and then obtain the behavior text data corresponding to the behavior sequence data based on the attribute text data corresponding to each piece of attribute data included in the behavior sequence data. The server can concatenate attribute text data corresponding to attribute data included in the same behavior event by using the predetermined character, to obtain behavior event text data, and then concatenate different behavior event text data by using the predetermined character, to obtain the behavior text data.

For example, for behavior sequence data including n behavior events, if each behavior event includes m pieces of attribute data, an attribute name is denoted as [k_1, k_2, k_3, . . . , k_m], and an attribute value corresponding to an i^{th} behavior event is denoted as [v_i1, v_i2, v_i3, . . . , v_im], behavior text data corresponding to the behavior sequence data can be “Event 1: {k_1 is v_11}, {k_2 is v_12, . . . , k_m is v_1m}, Event 2: {k_1 is v_21, k_2 is v_22, . . . , k_m is v_2m}, . . . , Event n: {k_1 is v_n1, k_2 is v_n2, . . . , k_m is v_nm}”.

Here, “Event” represents a behavior event, “is” is a predetermined connection sign for connecting the attribute name and the attribute value, attribute text data corresponding to attribute data included in the same behavior event is concatenated with “,”, and different behavior event text data are distinguished with “{ }” and concatenated with “,”, to finally obtain the behavior text data.

S103: Input the behavior text data into the to-be-trained recognition model, so that the recognition model outputs a recognition result for the behavior sequence data as a to-be-verified result based on the behavior text data, where the recognition result output by the recognition model is used to determine whether the behavior sequence data are realistic behavior sequence data of the user.

After obtaining the behavior text data, the server can input the obtained behavior text data into the to-be-trained recognition model, to output the recognition result for the behavior sequence data as the to-be-verified result by using the to-be-trained recognition model. The recognition result output by the recognition model is used to determine whether the behavior sequence data are the realistic behavior sequence data of the user.

It is worthwhile to note that an arrangement order of attribute data included in the behavior sequence data does not play a substantive role in determining whether the behavior sequence data are the realistic behavior sequence data of the user. However, in actual behavior sequence data, attribute data included in the behavior sequence data are usually arranged in a fixed order. This is because in a process in which the backend server of the application records the attribute data, there is inevitably a specific order. To avoid a case in which the to-be-trained recognition model forcibly binds a relationship between the order of the attribute data and the output recognition result, the server can randomly scramble a location of attribute data in event data of at least some behavior events included in the behavior sequence data in the event data to which the attribute data belong, to obtain out-of-order text data corresponding to the behavior sequence data. The server can rearrange attribute data in the original behavior sequence data, or can rearrange attribute data in the textual behavior sequence data.

For example, for any textual behavior sequence data, if the behavior sequence data include a behavior event that includes m pieces of attribute data, a textual representation of the behavior event can be “{k_1 is v_1, k_2 is v_2, . . . , k_m is v_m}”. In this case, the server can randomly scramble an arrangement order of attribute data included in the behavior event, that is, a textual representation of the behavior event after the scrambling can be “{k_2 is v_2, k_m is v_m, . . . , k_1 is v_1}” or “{k_m is v_m, k_1 is v_1, . . . , k_2 is v_2}”.

The arrangement order of the attribute data included in the behavior event is randomly scrambled, so that the arrangement order of the attribute data in the behavior event can be random to some extent. In this way, the to-be-trained recognition model cannot forcibly bind a relationship between the order of the attribute data in the behavior event and an output recognition result, to improve recognition accuracy of the recognition model.

On this basis, the server can input the out-of-order text data corresponding to the behavior sequence data into the to-be-trained recognition model, so that the to-be-trained recognition model outputs the recognition result for the behavior sequence data as the to-be-verified result based on the input out-of-order text data.

S104: Train the recognition model with an optimization objective of minimizing a deviation between the to-be-verified result and an actual recognition result corresponding to the behavior sequence data.

The server can train the to-be-trained recognition model based on the to-be-verified result output by the to-be-trained recognition model and with the optimization objective of minimizing the deviation between the to-be-verified result and the actual recognition result corresponding to the behavior sequence data, to recognize the simulated behavior information by using the trained recognition model.

It can be seen from the above-mentioned method that in this specification, an artificial intelligence model such as a large language model with strong performance is used as the to-be-trained recognition model, and the event data of each behavior event included in the behavior sequence data are converted into text data, so that the behavior sequence data can adapt to the to-be-trained recognition model, and a simulated behavior sequence generated through simulation can be recognized by using the strong performance of the recognition model. After training, the recognition model can determine authenticity of the simulated behavior sequence, so that the application developer develops a product that better matches a user behavior habit and more secure by using a realistic simulated behavior sequence.

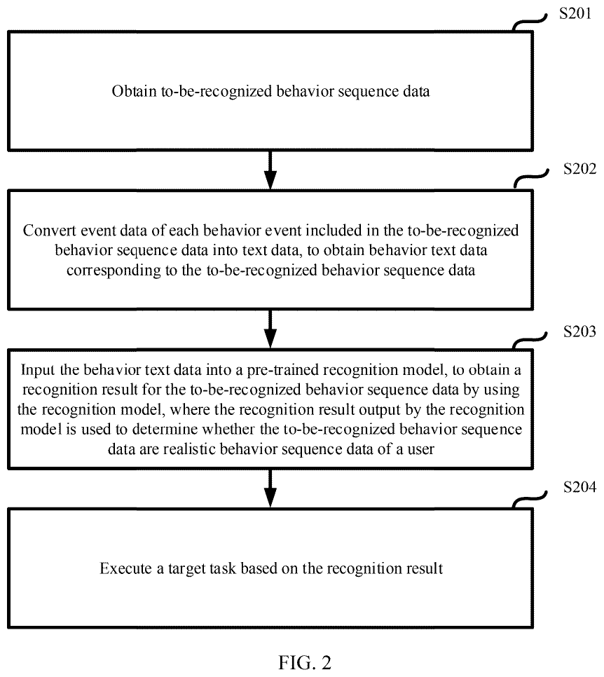

After completing training of the recognition model, the server can deploy the trained recognition model, to recognize the simulated behavior information by using the deployed recognition model, so as to determine authenticity of the simulated behavior information, as shown in FIG. 2.

FIG. 2 is a schematic flowchart illustrating a task execution method, according to this specification. The method includes the following steps.

S201: Obtain to-be-recognized behavior sequence data.

A server can obtain the to-be-recognized behavior sequence data. The to-be-recognized behavior sequence data can be simulated behavior sequence data whose authenticity needs to be determined. In this specification, the server can generate simulated behavior sequence data by using a predetermined behavior sequence generation model; and use the generated simulated behavior sequence data as the to-be-recognized behavior sequence data.

S202: Convert event data of each behavior event included in the to-be-recognized behavior sequence data into text data, to obtain behavior text data corresponding to the to-be-recognized behavior sequence data.

The server can convert the event data of each behavior event included in the to-be-recognized behavior sequence data into text data, and obtain the behavior text data corresponding to the to-be-recognized behavior sequence data. For each piece of attribute data included in the behavior sequence data, the server can connect an attribute name and an attribute value in the attribute data by using one or more predetermined text characters, to obtain attribute text data corresponding to the attribute data; and then obtain the behavior text data corresponding to the behavior sequence data based on the attribute text data corresponding to each piece of attribute data included in the behavior sequence data. A specific method for converting the to-be-recognized behavior sequence data into the behavior text data is basically the same as the method shown in step S102. Details are omitted here for simplicity.

S203: Input the behavior text data into a pre-trained recognition model, to obtain a recognition result for the to-be-recognized behavior sequence data by using the recognition model, where the recognition result output by the recognition model is used to determine whether the to-be-recognized behavior sequence data are realistic behavior sequence data of a user.

After obtaining the behavior text data corresponding to the behavior sequence data, the server can input the behavior text data into the pre-trained recognition model, to obtain the recognition result for the to-be-recognized behavior sequence data by using the recognition model. The recognition result output by the recognition model is used to determine whether the to-be-recognized behavior sequence data are the realistic behavior sequence data of the user.

S204: Execute a target task based on the recognition result.

After determining authenticity of the to-be-recognized behavior sequence data based on the recognition result, the server can add behavior sequence data whose recognition result is realistic to a predetermined target dataset based on an actual service scenario, to execute the target task based on each piece of behavior sequence data included in the target dataset.

It is worthwhile to note that in an actual service scenario, sometimes behavior sequence data whose recognition result is unrealistic may need to be used to execute some target tasks. In this specification, a case in which unrealistic behavior sequence data need to be used to execute the target task is not ruled out.

For example, in a service scenario of risk recognition, if a risk recognition model needs to be trained to recognize a risky behavior of a user, unrealistic behavior sequence data may need to be used as a training sample of the risk recognition model, so that the risk recognition model can determine improper user behaviors, and therefore the risk recognition model can recognize the risky behavior of the user.

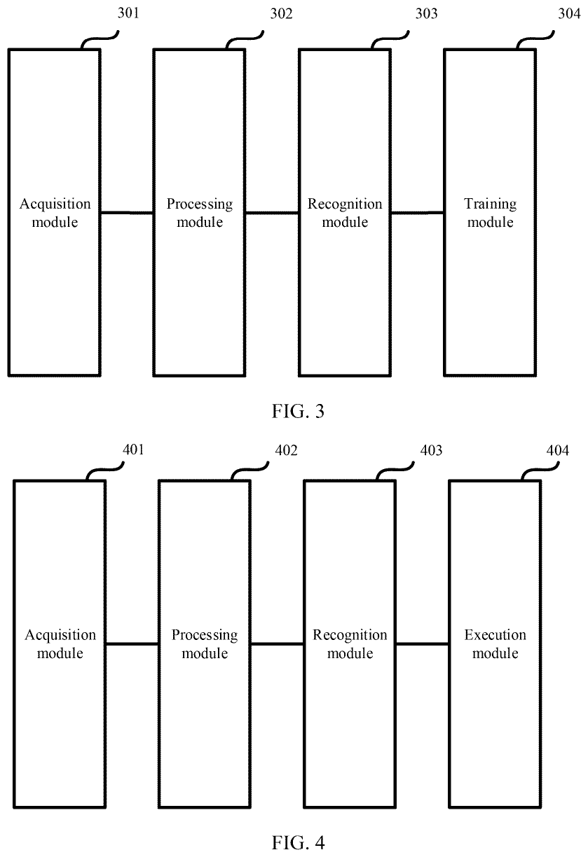

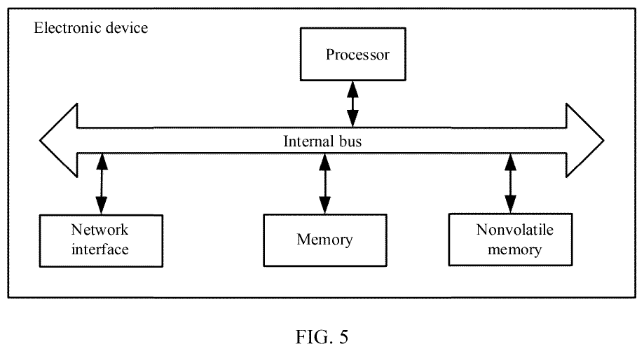

The model training method and the task execution method in one or more implementations of this specification are described above. Based on the same idea, this specification further provides a corresponding model training apparatus and task execution apparatus, as shown in FIG. 3 and FIG. 4.

FIG. 3 is a schematic diagram illustrating a model training apparatus, according to this specification. The apparatus includes: an acquisition module 301, configured to obtain behavior sequence data, where the behavior sequence data include event data of each behavior event corresponding to a user, and for each behavior event, the event data of the behavior event include a plurality of pieces of attribute data used to describe the behavior event; a processing module 302, configured to convert the event data of each behavior event included in the behavior sequence data into text data, to obtain behavior text data corresponding to the behavior sequence data; a recognition module 303, configured to input the behavior text data into a to-be-trained recognition model, so that the recognition model outputs a recognition result for the behavior sequence data as a to-be-verified result based on the behavior text data, where the recognition result output by the recognition model is used to determine whether the behavior sequence data are realistic behavior sequence data of the user; and a training module 304, configured to train the recognition model with an optimization objective of minimizing a deviation between the to-be-verified result and an actual recognition result corresponding to the behavior sequence data.

Optionally, the processing module 302 is specifically configured to: for each piece of attribute data included in the behavior sequence data, connect an attribute name and an attribute value in the attribute data by using one or more predetermined text characters, to obtain attribute text data corresponding to the attribute data; and obtain the behavior text data corresponding to the behavior sequence data based on the attribute text data corresponding to each piece of attribute data included in the behavior sequence data.

Optionally, before the behavior text data are input into the to-be-trained recognition model, the obtaining module 301 is further configured to obtain out-of-order text data corresponding to the behavior sequence data, where the out-of-order text data are obtained after a location of attribute data in event data of at least some behavior events included in the behavior sequence data in the event data to which the attribute data belong is rearranged; and the recognition module 303 is specifically configured to input the out-of-order text data into the to-be-trained recognition model, so that the recognition model outputs the recognition result for the behavior sequence data as the to-be-verified result based on the out-of-order text data.

FIG. 4 is a schematic diagram illustrating a task execution apparatus, according to this specification. The apparatus includes: an acquisition module 401, configured to obtain to-be-recognized behavior sequence data; a processing module 402, configured to convert event data of each behavior event included in the to-be-recognized behavior sequence data into text data, to obtain behavior text data corresponding to the to-be-recognized behavior sequence data; a recognition module 403, configured to input the behavior text data into a pre-trained recognition model, to obtain a recognition result for the to-be-recognized behavior sequence data by using the recognition model, where the recognition result output by the recognition model is used to determine whether the to-be-recognized behavior sequence data are realistic behavior sequence data of a user, and the recognition model is obtained through training by using the above-mentioned model method; and an execution module 404, configured to execute a target task based on the recognition result.

Optionally, the acquisition module 401 is specifically configured to generate simulated behavior sequence data by using a predetermined behavior sequence generation model; and use the simulated behavior sequence data as the to-be-recognized behavior sequence data.

Optionally, the execution module 404 is specifically configured to: if it is determined, based on the recognition result, that the to-be-recognized behavior sequence data are the realistic behavior sequence data of the user, add the behavior sequence data to a predetermined target dataset, to execute the target task based on each piece of behavior sequence data included in the target dataset.

This specification further provides a computer-readable storage medium. The storage medium stores a computer program, and the computer program can be configured to perform the model training method provided in FIG. 1 or perform the task execution method provided in FIG. 2.

This specification further provides a schematic structural diagram illustrating an electronic device corresponding to FIG. 1 or FIG. 2, as shown in FIG. 5.

FIG. 5 is a schematic structural diagram illustrating an electronic device corresponding to FIG. 1 or FIG. 2, according to this specification.

As shown in the figure, in terms of hardware, the electronic device includes a processor, an internal bus, a network interface, a memory, and a nonvolatile memory, and certainly may further include hardware needed by another service. The processor reads a corresponding computer program from the nonvolatile memory into the memory and runs the computer program, to implement the model training method in FIG. 1 or the task execution method in FIG. 2.

Certainly, in addition to software implementations, this specification does not exclude other implementations such as a logic device or a combination of software and hardware. In other words, an execution body of the following processing procedure is not limited to each logical unit, and can be hardware or a logic device.

Whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, an improvement to a method procedure can be implemented by using a hardware entity module. For example, a programmable logic device (PLD) (for example, a field programmable gate array (FPGA)) is such an integrated circuit, and a logical function of the PLD is determined by a user through device programming. The designer independently performs programming to “integrate” a digital system onto a PLD, without requesting a chip manufacturer to design and manufacture a dedicated integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicon Labs C8051F320. The memory controller can also be implemented as a part of control logic of a storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, an embedded microcontroller, etc. Therefore, the controller can be considered as a hardware component, and an apparatus included in the controller and configured to implement various functions can also be considered as a structure in the hardware component. Alternatively, an apparatus configured to implement various functions can be considered as both a software module for implementing a method and a structure in a hardware component.

The systems, apparatuses, modules, or units described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, during implementation of this specification, functions of units can be implemented in the same or more software and/or hardware.

A person skilled in the art should understand that the embodiments of this specification can be provided as methods, systems, or computer program products. Therefore, this specification can use a form of hardware only embodiments, software only embodiments, or embodiments with a combination of software and hardware. In addition, this specification can be in a form of a computer program product implemented on one or more computer-usable storage media (including but not limited to a magnetic disk storage, a CD-ROM, an optical storage, etc.) including computer-usable program code.

This specification is described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific way, so that the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory can include a form such as a non-persistent memory, a random access memory (RAM), or a nonvolatile memory in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

It is worthwhile to further note that the term “include”, “comprise”, or any other variant thereof is intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, this specification can use a form of hardware only embodiments, software only embodiments, or embodiments with a combination of software and hardware. In addition, this specification can be in a form of a computer program product implemented on one or more computer-usable storage media (including but not limited to a magnetic disk storage, a CD-ROM, an optical storage, etc.) including computer-usable program code.

This specification can be described in the general context of computer-executable instructions executed by a computer, for example, a program module. Usually, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environments, the program module can be located in both local and remote computer storage media including storage devices.

The embodiments of this specification are described in a progressive way. For the same or similar parts of the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely some embodiments of this specification and are not intended to limit this specification. A person skilled in the art can make various modifications and variations to this specification. Any modifications, equivalent replacements, improvements, etc. made without departing from the spirit and principle of this specification shall fall within the scope of the claims of this specification.

What is claimed is:

1. A computer-implemented method, comprising:
obtaining behavior sequence data, wherein the behavior sequence data comprise event data of each behavior event corresponding to a user, and for each behavior event, the event data of the behavior event comprise a plurality of pieces of attribute data used to describe the behavior event;
converting the event data of each behavior event comprised in the behavior sequence data into text data, to obtain behavior text data corresponding to the behavior sequence data;
inputting the behavior text data into a to-be-trained recognition model to output a recognition result for the behavior sequence data as a to-be-verified result based on the behavior text data, wherein the recognition result output by the to-be-trained recognition model is used to determine whether the behavior sequence data are realistic behavior sequence data of the user; and
training the to-be-trained recognition model with an optimization objective of minimizing a deviation between the to-be-verified result and an actual recognition result corresponding to the behavior sequence data.

2. The computer-implemented method according to claim 1, wherein for any attribute data comprised in the behavior sequence data, the attribute data are represented by using an attribute name and an attribute value corresponding to the attribute name; and
the converting the event data of each behavior event comprised in the behavior sequence data into text data, to obtain behavior text data corresponding to the behavior sequence data comprises:
for each piece of attribute data comprised in the behavior sequence data, connecting an attribute name and an attribute value in the attribute data by using one or more predetermined text characters, to obtain attribute text data corresponding to the attribute data; and
obtaining the behavior text data corresponding to the behavior sequence data based on the attribute text data corresponding to each piece of attribute data comprised in the behavior sequence data.

3. The computer-implemented method according to claim 1, wherein before the inputting the behavior text data into a to-be-trained recognition model, the method further comprises:
obtaining out-of-order text data corresponding to the behavior sequence data, wherein the out-of-order text data are obtained after a location of attribute data in event data of at least one or more behavior events comprised in the behavior sequence data is rearranged in the event data to which the attribute data belong; and
the inputting the behavior text data into a to-be-trained recognition model to output a recognition result for the behavior sequence data as a to-be-verified result based on the behavior text data comprises:
inputting the out-of-order text data into the to-be-trained recognition model to output the recognition result for the behavior sequence data as the to-be-verified result based on the out-of-order text data.

4. A computer-implemented method, comprising:
obtaining to-be-recognized behavior sequence data;
converting event data of each behavior event comprised in the to-be-recognized behavior sequence data into text data, to obtain behavior text data corresponding to the to-be-recognized behavior sequence data;
inputting the behavior text data into a recognition model, to obtain a recognition result for the to-be-recognized behavior sequence data by using the recognition model, wherein the recognition result output by the recognition model is used to determine whether the to-be-recognized behavior sequence data are realistic behavior sequence data of a user, and the recognition model is obtained through training according to a training method; and
executing a target task based on the recognition result.

5. The computer-implemented method according to claim 4, wherein the obtaining to-be-recognized behavior sequence data comprises:
generating simulated behavior sequence data by using a predetermined behavior sequence generation model; and
using the simulated behavior sequence data as the to-be-recognized behavior sequence data.

6. The computer-implemented method according to claim 4, wherein the executing a target task based on the recognition result comprises:
if it is determined, based on the recognition result, that the to-be-recognized behavior sequence data are the realistic behavior sequence data of the user, adding the to-be-recognized behavior sequence data to a target dataset, to execute the target task based on each piece of behavior sequence data comprised in the target dataset.

7. The computer-implemented method according to claim 4, wherein the training method comprises:
obtaining behavior sequence data, wherein the behavior sequence data comprise event data of each behavior event corresponding to a user, and for each behavior event, the event data of the behavior event comprise a plurality of pieces of attribute data used to describe the behavior event;
converting the event data of each behavior event comprised in the behavior sequence data into text data, to obtain behavior text data corresponding to the behavior sequence data;
inputting the behavior text data into a to-be-trained recognition model to output a recognition result for the behavior sequence data as a to-be-verified result based on the behavior text data, wherein the recognition result output by the to-be-trained recognition model is used to determine whether the behavior sequence data are realistic behavior sequence data of the user; and
training the to-be-trained recognition model with an optimization objective of minimizing a deviation between the to-be-verified result and an actual recognition result corresponding to the behavior sequence data.

8. The computer-implemented method according to claim 7, wherein for any attribute data comprised in the behavior sequence data, the attribute data are represented by using an attribute name and an attribute value corresponding to the attribute name; and
the converting the event data of each behavior event comprised in the behavior sequence data into text data, to obtain behavior text data corresponding to the behavior sequence data comprises:
for each piece of attribute data comprised in the behavior sequence data, connecting an attribute name and an attribute value in the attribute data by using one or more predetermined text characters, to obtain attribute text data corresponding to the attribute data; and
obtaining the behavior text data corresponding to the behavior sequence data based on the attribute text data corresponding to each piece of attribute data comprised in the behavior sequence data.

9. The computer-implemented method according to claim 7, wherein before the inputting the behavior text data into a to-be-trained recognition model, the training method further comprises:
obtaining out-of-order text data corresponding to the behavior sequence data, wherein the out-of-order text data are obtained after a location of attribute data in event data of at least one or more behavior events comprised in the behavior sequence data is rearranged in the event data to which the attribute data belong; and
the inputting the behavior text data into a to-be-trained recognition model to output a to-be-trained recognition result for the behavior sequence data as a to-be-verified result based on the behavior text data comprises:
inputting the out-of-order text data into the to-be-trained recognition model to output the recognition result for the behavior sequence data as the to-be-verified result based on the out-of-order text data.

10. A computer-implemented system, comprising:
one or more processors; and
one or more tangible, non-transitory, machine-readable media storing one or more instructions that, when executed by the one or more processors, perform one or more operations comprising:
obtaining behavior sequence data, wherein the behavior sequence data comprise event data of each behavior event corresponding to a user, and for each behavior event, the event data of the behavior event comprise a plurality of pieces of attribute data used to describe the behavior event;
converting the event data of each behavior event comprised in the behavior sequence data into text data, to obtain behavior text data corresponding to the behavior sequence data;
inputting the behavior text data into a to-be-trained recognition model to output a recognition result for the behavior sequence data as a to-be-verified result based on the behavior text data, wherein the recognition result output by the to-be-trained recognition model is used to determine whether the behavior sequence data are realistic behavior sequence data of the user; and
training the to-be-trained recognition model with an optimization objective of minimizing a deviation between the to-be-verified result and an actual recognition result corresponding to the behavior sequence data.

11. The computer-implemented system according to claim 10, wherein for any attribute data comprised in the behavior sequence data, the attribute data are represented by using an attribute name and an attribute value corresponding to the attribute name; and
the converting the event data of each behavior event comprised in the behavior sequence data into text data, to obtain behavior text data corresponding to the behavior sequence data comprises:
for each piece of attribute data comprised in the behavior sequence data, connecting an attribute name and an attribute value in the attribute data by using one or more predetermined text characters, to obtain attribute text data corresponding to the attribute data; and
obtaining the behavior text data corresponding to the behavior sequence data based on the attribute text data corresponding to each piece of attribute data comprised in the behavior sequence data.

12. The computer-implemented system according to claim 10, wherein before the inputting the behavior text data into a to-be-trained recognition model, the one or more operations further comprise:
obtaining out-of-order text data corresponding to the behavior sequence data, wherein the out-of-order text data are obtained after a location of attribute data in event data of at least one or more behavior events comprised in the behavior sequence data is rearranged in the event data to which the attribute data belong; and
the inputting the behavior text data into a to-be-trained recognition model to output a recognition result for the behavior sequence data as a to-be-verified result based on the behavior text data comprises:
inputting the out-of-order text data into the to-be-trained recognition model to output the recognition result for the behavior sequence data as the to-be-verified result based on the out-of- order text data.

13. A computer-implemented system, comprising:
one or more processors; and
one or more tangible, non-transitory, machine-readable media storing one or more instructions that, when executed by the one or more processors, perform one or more operations comprising:
obtaining to-be-recognized behavior sequence data;
converting event data of each behavior event comprised in the to-be-recognized behavior sequence data into text data, to obtain behavior text data corresponding to the to-be-recognized behavior sequence data;
inputting the behavior text data into a recognition model, to obtain a recognition result for the to-be-recognized behavior sequence data by using the recognition model, wherein the recognition result output by the recognition model is used to determine whether the to-be-recognized behavior sequence data are realistic behavior sequence data of a user, and the recognition model is obtained through training according to a training method; and
executing a target task based on the recognition result.

14. The computer-implemented system according to claim 13, wherein the obtaining to-be-recognized behavior sequence data comprises:
generating simulated behavior sequence data by using a predetermined behavior sequence generation model; and
using the simulated behavior sequence data as the to-be-recognized behavior sequence data.

15. The computer-implemented system according to claim 13, wherein the executing a target task based on the recognition result comprises:
if it is determined, based on the recognition result, that the to-be-recognized behavior sequence data are the realistic behavior sequence data of the user, adding the to-be-recognized behavior sequence data to a target dataset, to execute the target task based on each piece of behavior sequence data comprised in the target dataset.

16. The computer-implemented system according to claim 13, wherein the training method comprises:
obtaining behavior sequence data, wherein the behavior sequence data comprise event data of each behavior event corresponding to a user, and for each behavior event, the event data of the behavior event comprise a plurality of pieces of attribute data used to describe the behavior event;
converting the event data of each behavior event comprised in the behavior sequence data into text data, to obtain behavior text data corresponding to the behavior sequence data;
inputting the behavior text data into a to-be-trained recognition model to output a recognition result for the behavior sequence data as a to-be-verified result based on the behavior text data, wherein the recognition result output by the to-be-trained recognition model is used to determine whether the behavior sequence data are realistic behavior sequence data of the user; and
training the to-be-trained recognition model with an optimization objective of minimizing a deviation between the to-be-verified result and an actual recognition result corresponding to the behavior sequence data.

17. The computer-implemented system according to claim 16, wherein for any attribute data comprised in the behavior sequence data, the attribute data are represented by using an attribute name and an attribute value corresponding to the attribute name; and
the converting the event data of each behavior event comprised in the behavior sequence data into text data, to obtain behavior text data corresponding to the behavior sequence data comprises:
for each piece of attribute data comprised in the behavior sequence data, connecting an attribute name and an attribute value in the attribute data by using one or more predetermined text characters, to obtain attribute text data corresponding to the attribute data; and
obtaining the behavior text data corresponding to the behavior sequence data based on the attribute text data corresponding to each piece of attribute data comprised in the behavior sequence data.

18. The computer-implemented system according to claim 16, wherein before the inputting the behavior text data into a to-be-trained recognition model, the training method further comprises:
obtaining out-of-order text data corresponding to the behavior sequence data, wherein the out-of-order text data are obtained after a location of attribute data in event data of at least one or more behavior events comprised in the behavior sequence data is rearranged in the event data to which the attribute data belong; and
the inputting the behavior text data into a to-be-trained recognition model to output a to-be-trained recognition result for the behavior sequence data as a to-be-verified result based on the behavior text data comprises:
inputting the out-of-order text data into the to-be-trained recognition model to output the recognition result for the behavior sequence data as the to-be-verified result based on the out-of-order text data.
